(19) United States
(12) Patent Application Publication
(10) Pub. No.: US 2007/0211896 A1
(43) Pub. Date: Sep. 13, 2007

(54) ENCRYPTION AND DECRYPTION PROGRAMS AND CRYPTOSYSTEM

(75) Inventors: Takashi Mishima, Fujisawa (JP); Hidenobu Seki, Fujisawa (JP); Daiji Sanai, Fujisawa (JP)

Correspondence Address: SUGHRUE MION, PLLC, 2100 PENNSYLVANIA AVENUE, N.W., SUITE 800, WASHINGTON, DC, 20037, US

(73) Assignee: Yamatake corporation, Tokyo (JP)

(21) Appl. No.: 11/574,388

(22) PCT Filed: Aug. 30, 2005
(86) PCT No.: PCT/JP05/15698

§ 371 Date: Feb. 27, 2007

(30) Foreign Application Priority Data
Aug. 31, 2004 (JP) 2004-251631

(51) Int. Cl. H04L 9/28; H04L 9/14

(52) U.S. Cl. 380/44; 380/28

(57) ABSTRACT

An encryption computer program product, in a computer readable medium, including instructions executed by a computer for causing the computer to implement a method of encrypting input data, comprising, generating key data for each unit data constituting the input data; encrypting unit data with the key data to creating encrypted data, storing the encrypted data into a storage section, and recording the key data in a key database without correlation with the encrypted data.

### TECHNICAL FIELD

The present invention relates to an encryption program, a decryption program and a cryptosystem and, more particularly, to an encryption program, a decryption program and a cryptosystem for preventing file data information leakage.

### BACKGROUND ART

In recent years with advancing computer technology, most information is controlled by computers. As the information content controlled by computers increases, the classified information controlled by the computers increases accordingly. The increase in information content causes a heavy load of information control and raises a problem of information leakage.

To address these problems, various techniques for preventing a malicious third party from accessing the classified information controlled by computers have been developed. A typical method is to encrypt a file which contains classified information with a password so that a third party who does not know the password cannot access the information in the file. Another typical method is to encrypt a file so that a third party who does not know how to decrypt the file cannot read the contents of the file because the information is encrypted.

However, even when a file is encrypted, information in the file becomes accessible if a decryption method is known. To prevent this, numerous studies have been conducted to develop a strong, undefeatable encryption technology (for example, see Patent Document 1).

[Patent Document 1] Japanese Unexamined Patent Application Publication No. 2002-111659

### DISCLOSURE OF THE INVENTION

Problems to be Solved by the Invention

Even with a use of such encryption technology, however, decryption is still possible for a third party who does not know necessary key information by taking a long time through a method called “brute force attack”, which exhaustively generates and inputs every possible information as a key to decryption. Further, recent classified information leakage can occur due to an insider who knows a decryption method, which is also a problem to be addressed.

The present invention has been accomplished to solve the above problems and an object of the present invention is thus to provide an encryption and a decryption program and a cryptosystem which are advanced enough to prevent information leakage.

Means for Solving the Problems

According the present invention, there is provided an encryption computer program product, in a computer readable medium, including instructions executed by a computer for causing the computer to implement a method of encrypting input data, comprising, generating key data for each unit data constituting the input data, encrypting unit data with the key data to creating encrypted data, storing the encrypted data into a storage section, and recording the key data in a key database without correlation with the encrypted data. This configuration enables to perform encryption which makes it difficult to interpret the entire data.

According to the present invention, there is provided an encryption computer program product, in a computer readable medium, including instructions executed by a computer for causing the computer to implement a method of encrypting input data, comprising, selecting arbitrary key data from a key database storing key data without correlation with data to be encrypted, for each unit data constituting the input data, encrypting unit data with the key data to create encrypted data, storing the encrypted data into a storage section, recording the key data in a key database without correlation with the encrypted data. This configuration enables to perform encryption which makes it difficult to interpret the entire data.

According to the present invention, there is provided an encryption computer program product, in a computer readable medium, including instructions executed by a computer for causing the computer to implement a method of encrypting input data, comprising, encrypting unit data constituting the input data with key data individually set for each unit data to create encrypted data, generating data for key data checking based on each unit data constituting the input data, storing the encrypted data and the data for key data checking into a storage section in correlation with each other; and recording the key data in a key database without correlation with the encrypted data. This configuration enables to perform encryption which makes it difficult to interpret the entire data.

The data for key data checking may be hash data.

The input data may be data for spreadsheet software, and the constitutional unit may be a cell unit of the spreadsheet software. This enables a use of existing spreadsheet software without being aware of encryption.

The key database may contain key data used for encryption and dummy data not actually used for encryption. This makes it difficult to find correct key data to thereby improve security.

The key database may be stored in the storage means as file data, and the file data may have a larger size than an external storage medium recordable from the computer. This makes it difficult to steal data to thereby improve security.

According to the present invention, there is provided a decryption computer program product, in a computer readable medium, including instructions executed by a computer for causing the computer to implement a method of decrypting encrypted data, comprising, retrieving one key data from a key database according to selection of unit data constituting data, decrypting the selected data with the key data, generating data for key data checking from the decrypted data, and comparing the generated data for key data checking and data for key data checking previously correlated with the decrypted data to determine whether the retrieved key data corresponds to the unit data. This configuration reduces the possibility to find key data from the key database.

According to the present invention, there is provided a decryption computer program product, in a computer readable medium, including instructions executed by a computer for causing the computer to implement a method of decrypting encrypted data, comprising, (a) retrieving one key data from a key database according to selection of unit data constituting data, (b) decrypting the selected data with the key data, (c) generating data for key data checking from the decrypted data, (d) comparing the generated data for key data checking and data for key data checking previously correlated with the decrypted data to determine whether the retrieved key data corresponds to the unit data, (e) repeating (a) to (d) until a determination result indicates that retrieved key data corresponds to the unit data and (f) displaying the decrypted data. This configuration reduces the possibility to find key data from the key database.

The data for key data checking may be hash data.

The data may be data for spreadsheet software, and the constitutional unit may be a cell unit of the spreadsheet software. This enables a use of existing spreadsheet software without being aware of decryption.

(f) displaying may include dividing display contents into segments and alternately switching and displaying each segment at a high speed. This prevents information leakage through screen capturing.

(f) displaying may include displaying data after a predetermined time period from data selection. This prevents information leakage through direct viewing of all data.

According to the present invention, there is provided a cryptosystem for executing encryption and decryption of input data, comprising, a section for generating key data individually set for each unit data constituting the input data, a section for encrypting unit data with the key data to create encrypted data, a section for storing the encrypted data and data for key data checking into a storage section in correlation with each other, a section for retrieving key data from a key database according to selection of unit data constituting data, a section for decrypting the selected data with the key data, a section for generating data for key data checking from the decrypted data, and a section for comparing the generated data for key data checking and data for key data checking previously correlated with the decrypted data to determine whether the retrieved key data corresponds to the unit data. This configuration enables to perform encryption which makes it difficult to interpret the entire data.

Advantages of the Invention

The present invention provides an encryption and a decryption program and a cryptosystem which are strong enough to prevent information leakage.

### BRIEF DESCRIPTION OF THE DRAWINGS

FIG. 1 is a view showing an overall configuration of a computer and a server according to the present invention;

FIG. 2 is a view showing a detailed configuration of a computer and a server according to the present invention;

FIG. 3 is a flowchart showing the process flow of encryption according to the present invention;

FIG. 4 is a flowchart showing the process flow of decryption according to the present invention;

FIG. 5A is a view showing an example of a screen display according to the present invention;

FIG. 5B is a view showing an example of a screen display according to the present invention;

FIG. 6 is a view showing an example of a screen display according to the present invention;

FIG. 7A is a view showing an example of a screen display according to the present invention; and

FIG. 7B is a view showing an example of a screen display according to the present invention.

### DESCRIPTION OF REFERENCE NUMERALS

1 COMPUTER

2 COMPUTER

201 CPU

204 MEMORY

205 KEYBOARD MOUSE CONTROLLER

206 KEYBOARD

207 MOUSE

208 VGA

209 VRAM

210 DAC/LCDC

211 DISPLAY DEVICE

213 HARD DISK DEVICE

214 ROM

215 SERIAL PORT

216 PARALLEL PORT

218 COMMUNICATION ADAPTER

219 FLEXIBLE DISK CONTROLLER

220 FLEXIBLE DISK DEVICE

225 CONTROLLER

226 DRIVE

### BEST MODES FOR CARRYING OUT THE INVENTION

### First Embodiment

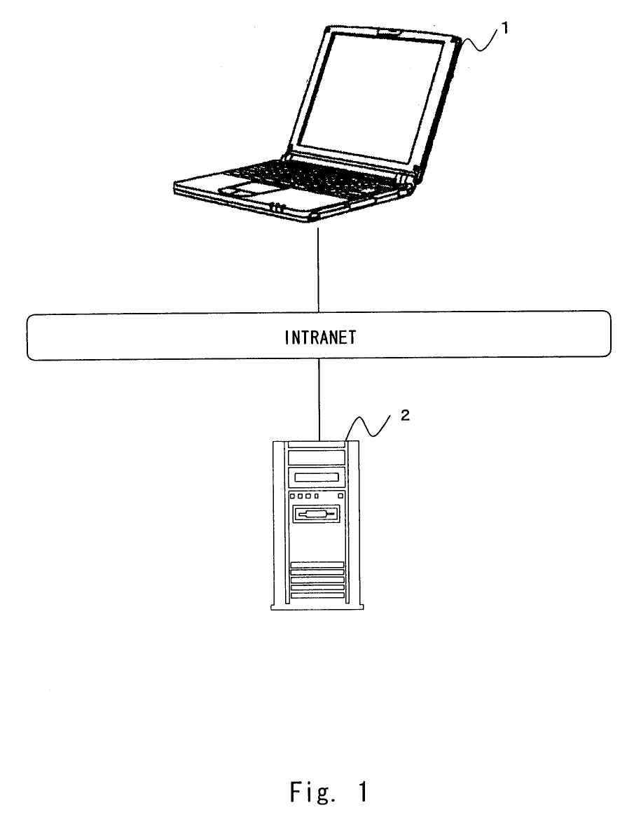

FIG. 1 shows an exemplary configuration of a computer according to a first embodiment of the present invention. A computer 1 and a computer 2 are connected through a network. The network is preferably the one that is accessible within a limited area, such as an intranet, rather than the one that is universally connectable, such as the Internet.

The computer 1 can send and receive files to/from the computer 2 through the network, and it may be a commercially available personal computer (PC). The number of computers is not necessarily two, and three or more computers may be used. The computer 2 can also send and receive files to/from the computer 1 through the network, and it may be a commercially available PC.

The program and data to operate on the computer 1 are supplied from an external storage medium such as CD-ROM or downloaded from an external server through the network and installed onto the computer 1. The computers 1 and 2 send and receive data according to need. Although the encryption and decryption programs of the first embodiment are operable on the computer 1 alone, a key database used for the encryption and decryption process can be shared if the computer 1 is connected with the computer 2.

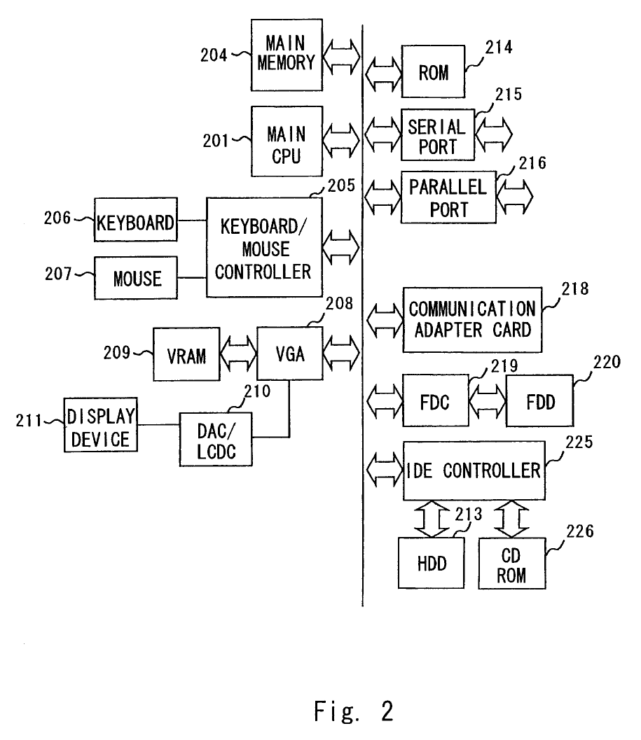

FIG. 2 is an exemplary hardware configuration of the computer 1 according to the first embodiment of the present invention. The server 2 may have the similar configuration. The computer 1 includes a central processing unit (CPU) 201 and a memory 204. The CPU 201 and the memory 204 are connected through a bus to a hard disk device 213 as an auxiliary storage device. Storage medium drivers such as a flexible disk device 220, the hard disk device 213 and a CD-ROM drive 226 are connected to the bus via controllers such as a flexible disk controller 219 and an IDE controller 225. A portable storage medium such as a flexible disk is inserted to the storage medium driver such as the flexible disk device 220.

The storage medium may store a computer program for supplying instructions to the CPU 201 in association with an operating system to implement the present embodiment. Each section described in this embodiment is one of computer programs. The data generated by a program of this embodiment is stored in the memory 204 and also stored in the hard disk device 213 when needed. A computer program is executed by being loaded to the memory 204. A computer program may be stored in a storage medium by being compressed or divided into a plurality of segments. The hardware configuration typically includes user interface hardware.

The user interface hardware includes pointing devices (such as a mouse 207 and a joy stick) and a keyboard 206 for inputting data, and a display device 211 such as a liquid crystal display for presenting visual data to users. Image data is stored in a VRAM 209 and supplied to the display device 211 through a VGA controller 208 and a DAC/LCD controller (LCDC) 210. In this embodiment, all user inputs are provided via the mouse 207, the keyboard 206, or the like. It is possible to connect a modem through a serial port 215 so as to make connection with a network via the serial port 215 or a communication adapter 218 to thereby communicate with another computer system such as the server 2. The above configuration may be modified as needed.

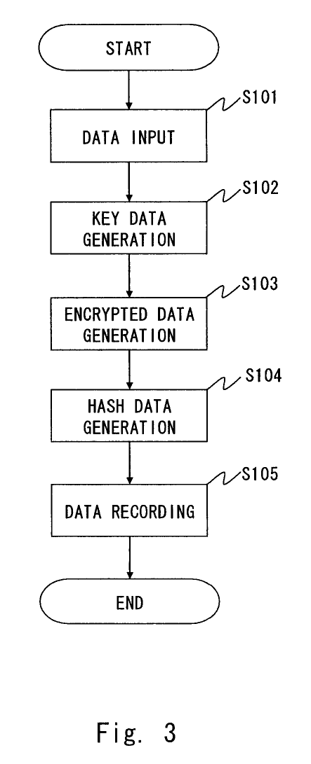

Referring now to the flowchart of FIG. 3, the process flow of data encryption according to the first embodiment of the present invention is described hereinafter. The process employs commercially available spreadsheet software, and an encryption program is integrated into the spreadsheet software and operates therein. The spreadsheet software is installed into the hard disk device 213 and loaded onto the memory 204 for operation. The CPU 201 in this process operates in response to instructions from the encryption program.

Firstly, a user inputs data into the spreadsheet software in the same manner as when using a spreadsheet software normally (S101). In typical spreadsheet software, data is input in units of cells. Generally, a user selects and determines a cell to which data is to be input using the mouse 207 and then determines the data to be input to the selected cell using the keyboard 206. However, the way to input the data depends on the operation of the spreadsheet software, and the mouse 207 or the like may be used instead of the keyboard 206. Input data mainly contain a character string and numerical values, and the input data is converted into character data or numerical data by the CPU 201 and stored into the memory 204 for each cell.

After inputting data to the cell, the CPU 201 generates key data for encrypting the cell where the data is input (S102). The key data generation may typically generate random numbers and use them as key data. The key data of random numbers is more difficult to predict than key data generated by other methods. Although an algorithm to generate random numbers is preferably a special algorism that is more unpredictable, a use of a random number generator function which is provided in an existing library still enhances the unpredictability compared with no use of random numbers.

The generation of key data is performed cell by cell, and the key data generated for each cell is stored into a key database recorded in the hard disk device 213. Alternatively, it is possible to retrieve one key data stored in a key database rather than generating key data. Setting different key data from cell to cell avoids that all data becomes accessible when one key data is stolen.

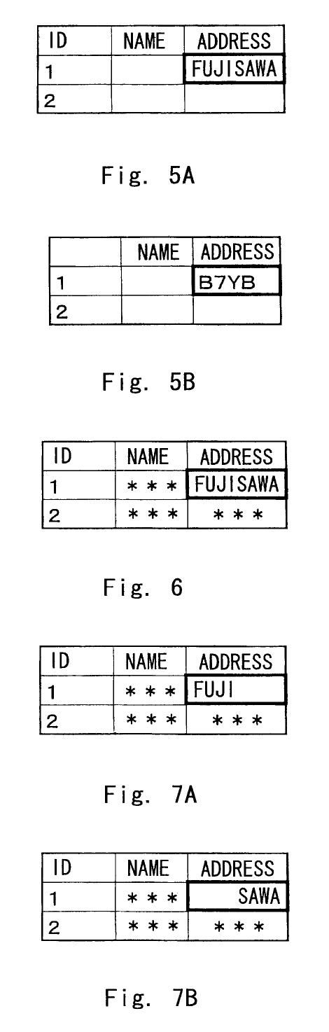

After generating key data, the CPU 201 encrypts the input cell data (S103) to thereby create encrypted data. Although an encryption method is not particularly limited, an encryption system that involves encryption and decryption using a key such as public key encryption is employed. The key data used for the encryption is a binary bit string. As a bit length is longer, the number of possible combinations of key data is larger to help prevent a successful brute force attack, thus improving security. This embodiment employs key data of 128-bit length. FIGS. 5A and 5B show an example of data before and after encryption. FIG. 5A shows non-encrypted data immediately after input, and FIG. 5B shows encrypted data. Although the positions of the cells of the data before encryption and the data after encryption are the same in the example shown in FIGS. 5A and 5B, they are not always the same. Even if the cell positions are different, the cell position is not displaced upon decryption because the encrypted data contains information about the cell position.

In addition to the encryption of the cell data, the CPU 201 generates hash data from the input cell data (S104). The hash data is necessary for verifying that decryption occurs correctly. The encrypted cell data and hash data are stored into the memory 204. Further, the cell data and hash data may be recorded in the hard disc device 213 as a file according to an operation by a user.

The hash data is briefly described hereinafter. The hash data is mainly used for data authentication, and the use of hash data improves the reliability of data. This embodiment uses the hash data to verify that the key data used for decryption is correct.

Hash data is generated by entering original data into a specific function expression to produce 8-bit data. The expression used is not particularly limited, but the use of a complex function is preferable to prevent recognition. For example, the use of a hash function SHA-1 allows generation of 20-byte hash data with completely different data in all bytes by merely converting 1-bit of original data.

The hash data generated in this manner is stored for use when verifying that decrypted data is correct. Specifically, if decrypted data is correct, the hash data generated based on the decrypted cell data should have the same value.

A key database stores all keys for the cells input to the spreadsheet software but does not store information about which key corresponds to which cell in order to prevent a successful analysis of the key database and enhance security. The correspondence between keys and cells is confirmed using the above-described hash data. A specific confirmation method is described later.

The key database may also contain dummy key data. This makes it difficult to find a key necessary for decryption. Further, increasing the size of a file of the key database helps prevent copying of the whole file to an external storage medium such as CD-R or DVD-R to steal the data.

After generating all data, the CPU 201 correlates the generated encrypted data and hash data with each other and stores them into the memory 204. The CPU 201 may further record them into the hard disk device 213 when needed (S105). The encryption process ends upon recording of the data.

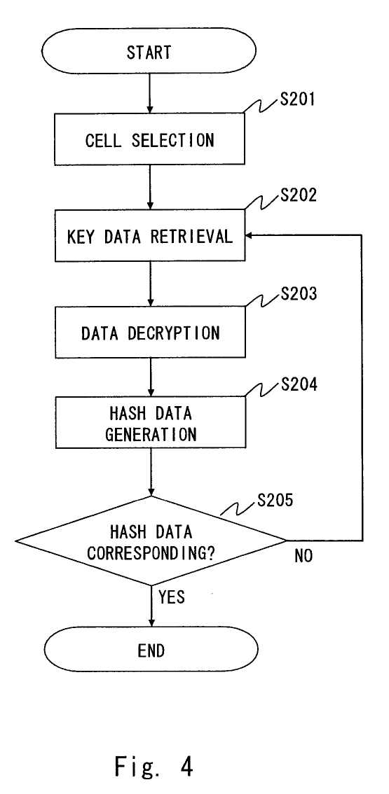

Referring then to the flowchart of FIG. 4, the process flow of data decryption according to the first embodiment of the present invention is described hereinafter. Like the encryption program, a decryption program is integrated into spreadsheet software, so that a user can use the spreadsheet software without being aware of the encryption or decryption operation. The CPU 201 in this process also operates in response to instructions from the decryption program.

Firstly, a user selects a cell to which he/she wants to access the contents from the data of the spreadsheet software (S201). The operation to select a cell is typically performed using the mouse 207. After the cell selection, the CPU 201 retrieves one key data from the key database (S202). It then decrypts the data using the retrieved key (S203).

As described earlier, the key database stores key data for each cell but does not store information about which key data corresponds to which cell. Therefore, the data which is decrypted using the retrieved key data is not always the key data corresponding to the relevant cell. Thus, the CPU 201 generates hash data from decrypted data upon decryption (S204) and checks if the hash data is correct (S205), thereby verifying if the key data corresponds to the relevant cell. If the hash data is correct, the decryption process completes.

If, on the other hand, the hash data is not correct, it means that the retrieved key data does not correspond to the relevant cell. In such a case, the CPU 201 retrieves another key data from the key database and performs decryption again. This process is repeated until correct key data is retrieved. The correct key data can be found in this process without fail because it is recorded in the key database upon encryption. Although the search is performed on all the key data stored in the key database until the correct key data is found, if the key database contains dummy key data, it is possible to prevent the retrieval of dummy key data by predetermining the positions of dummy key data.

A user can access the contents of the decrypted cell data in the same manner as when using spreadsheet software normally. It is possible to control such that the contents of only the selected cell are visible while the contents of the other cell are invisible with “***” or the like displayed therein to thereby prevent information leakage through direct viewing of the screen. On the other hand, it is possible to allow the contents of all cells to be visible for better visibility during data input.

Further, it is possible to display data after an appropriate time delay rather than immediately after decryption of the cell. This hinders a stealthy glance at all data by an insider, which suppresses data leakage from the inside. The delay time is preferably about 1 to 2 seconds which do not interfere with normal work.

Furthermore, if the contents of the cell are numerical or text data, it is possible to alternately display every other character at a high speed as shown in FIGS. 7A and 7B. In such a case, a user looking at the screen can still understand the contents by persistence of vision. On the other hand, only every other character is displayed on a captured screen. This prevents information leakage through screen capturing.

### Other Embodiments

Although the encryption and decryption are applied to the data of spreadsheet software in the above-described example, they may be applied to the data of document preparation software by setting different key data from line to line, rather than from cell to cell, for encryption. Further, the data of image creation software may be encrypted block by block. The encryption and decryption are compatible with various data as long as the data can be divided into reference units.

The above-described example performs encryption and decryption on the cell data only, not on the hash data. It is, however, possible to encrypt and decrypt the hash data as well.

### Industrial Applicability

The present invention may be applied to spreadsheet software on which a program such as macro is executable.

1-14. (canceled)

15. An encryption computer program product, in a computer readable medium, including instructions executed by a computer for causing the computer to implement a method of encrypting input data, comprising:
(a) generating key data for each unit data constituting the input data;
(b) encrypting unit data with the key data to creating encrypted data;
(c) storing the encrypted data into a storage section; and
(d) recording the key data in a key database without correlation with the encrypted data.

16. An encryption computer program product according to claim 15, wherein
(a) generating key data includes selecting arbitrary key data from a key database storing key data without correlation with data to be encrypted, for each unit data constituting the input data.

17. An encryption computer program product according to claim 15, wherein
(b) encrypting unit data includes encrypting unit data constituting the input data with key data individually set for each unit data to create encrypted data.

18. An encryption computer program product according to claim 15, further comprising:
(e) generating data for key data checking based on each unit data constituting the input data, and wherein
(c) storing the encrypted data includes storing the encrypted data and the data for key data checking into a storage section in correlation with each other.

19. The encryption program product according to claim 18, wherein the data for key data checking is hash data.

20. The encryption program product according to claim 15, wherein
the input data is data for spreadsheet software, and the constitutional unit is a cell unit of the spreadsheet software

21. The encryption program product according to claim 15, wherein the key database contains key data used for encryption and dummy data not actually used for encryption.

22. The encryption program product according to claim 15, wherein
the key database is stored in the storage section as file data, and
the file data has a larger size than an external storage medium recordable from the computer.

23. A decryption computer program product, in a computer readable medium, including instructions executed by a computer for causing the computer to implement a method of decrypting encrypted data, comprising:
(a) retrieving one key data from a key database according to selection of unit data constituting data;
(b) decrypting the selected data with the key data;
(c) generating data for key data checking from the decrypted data; and
(d) comparing the generated data for key data checking and data for key data checking and data for key data checking previously correlated with the decrypted data to determine whether the retrieved key data corresponds to the unit data.

24. A decryption computer program product, according to claim 23, further comprising:
(e) repeating (a) to (d) until a determination result indicates that retrieved key data corresponds to the unit data; and
(f) displaying the decrypted data.

25. The decryption program product according to claim 23, wherein the data for key data checking is hash data.

26. The decryption program product according to claim 23, wherein
the data is data for spreadsheet software, and
the constitutional unit is a cell unit of the spreadsheet software.

27. The decryption program product according to claim 24, wherein
(f) displaying includes dividing display contents into segments and alternately switching and displaying each segment at a high speed.

28. The decryption program product according to claim 24,
(f) displaying includes displaying data after a predetermined time period from data selection.

29. The decryption program product according to claim 27, wherein
(f) displaying includes displaying data after a predetermined time period from data selection.

30. A cryptosystem for executing encryption and decryption of input data, comprising:
a section for generating key data individually set for each unit data constituting the input data;
a section for encrypting unit data with the key data to create encrypted data;
a section for storing the encrypted data and data for key data checking into a storage section in correlation with each other;
a section for retrieving key data from a key database
according to selection of unit data constituting data;
a section for decrypting the selected data with the key data; a section for generating data for key data checking from
the decrypted data; and
a section for comparing the generated data for key data checking and data for key data checking previously correlated with the decrypted data to determine whether the retrieved key data corresponds to the unit data.
